(19) United States
(12) Patent Application Publication
(10) Pub. No.: US 2006/0011074 A1
(43) Pub. Date: Jan. 19, 2006

(54) Systems and methods for connecting truss connector plates to truss members

(76) Inventor: Joseph F. Pinkerton, Austin, TX (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/895,662

(22) Filed: Jul. 20, 2004

Related U.S. Application Data
(60) Provisional application No. 60/587,885, filed on Jul. 13, 2004.

(51) Int. Cl. B30B 13/00; B30B 3/02

(52) U.S. Cl. 100/913; 100/35; 100/48; 100/210; 100/226

(57) ABSTRACT

Systems and methods are provided that affix truss connector plates to truss members. More particularly, vibrational energy is provided to the truss connector plate when the truss connector plate is being affixed to the truss member in order to reduce the amount of strain in the truss member. The truss connector plate is affixed to the truss member by way of, for example, a pressing or rolling system. The vibrational energy may be generated by accelerating the pressing or rolling member before that member comes into contact with a truss connector plate.

### CROSS-REFERENCE TO RELATED APPLICATION

This non-provisional application claims the benefit of Provisional Application No. ______ entitled “Systems and Methods for Connecting Truss Connector Plates,” which is hereby incorporated by reference herein in its entirety.

### BACKGROUND OF THE INVENTION

This invention relates to systems and methods of connecting truss members. More particularly, this invention relates to reducing stress in truss members when truss connector plates are pressed, or rolled, into truss members.

Truss members are traditionally affixed together by truss connector plates. In this manner, truss connector plates may be utilized to form truss members into a variety of different structures. Truss connector plates are traditionally seated into truss members by a pressing or rolling system. Due to the physical attributes of the truss connector plates, a large amount of force is traditionally required to press, or roll, a truss connector plate into a truss member. Such a large force occasionally causes the truss member, that is passively receiving the force via the truss connector plate, to structurally fail (e.g., splinter or crack). It is therefore desirable to provide a system of affixing truss connector plates to truss members without introducing a large amount of stress, or strain, to the truss members.

One example of a prior art system that affixes truss connector plates to truss members is discussed in Wright U.S. Pat. No. 5,285,720 filed on Oct. 2, 1992 and entitled “Apparatus and Method of Manufacturing Wood Trusses” (hereinafter “Wright”). Wright includes two vibrators that reduce the amount of stress in the truss members when truss connector plates are affixed to the truss members.

Wright is deficient because two external vibrators are required to reduce the amount of stress. Wright is further deficient because constant vibrational forces are provided. Such constant vibrational forces constantly wear down the entire press, or rolling, system. It is therefore desirable to provide an improved reduced-stress system for affixing truss connector plates to truss members.

### SUMMARY OF THE INVENTION

It is an object of the present invention to provide reduced-stress pressing and rolling systems and methods for affixing truss connector plates to truss members.

It is also an object of the present invention to provide pressing and rolling systems and methods that are operable to provide vibrations of varying strength, and of varying duration, to a truss connector plate.

It is yet another object of the present invention provide autonomous pressing and rolling systems and methods for affixing truss connector plates to truss members.

A connecting system is provided with an affixing member that affixes truss connector plates to truss members. Such an affixing member may be, for example, a presser or a roller. Generally, the connecting system operates as follows. The affixing member is accelerated and stopped before coming into contact with a truss connector plate. Such an acceleration or deceleration of movement of the affixing member may cause the affixing member to vibrate. In this manner, vibrational energy may be stored in the affixing member. The vibrating affixing member may then be forced into a truss connector plate such that the truss connector plate receives a portion of the vibrational energy from the affixing manner. As a result, a vibrating truss connector plate is affixed to one or more truss members. A vibrating truss connector plate may be seated into a truss member with less force, and faster, than a truss connector plate that is not vibrating.

One or more processors may be provided to provide control signals to one or more connecting systems. Such processors may, for example, retrieve information from memory, or a database, and use this retrieved information to generate control signals to one or more connecting systems. Control signals provided to a connecting system may differ, for example, depending on the type of material of the truss member, the type of material of the truss connector plate, the dimensions of the truss member, the dimensions of the truss connector plate, or the characteristics of a particular connection system.

In this manner, the connecting system may, for example, accelerate the affixing member at a particular acceleration (or to a particular speed) and decelerate (or stop the movement of) the affixing member at a particular distance from the truss connector plate for a particular period of time depending on the control signals that the connecting system receives. Adjusting the characteristics and operation of such a connecting system may, for example, change the strength of the vibrations or the length of time that the affixing member vibrates. Accordingly, the vibrational profile of the affixing member may be changed. In this manner, particular vibrational profiles may be utilized for particular operations.

As in another embodiment, vibrational energy may be generated by an affixing member without stopping, or decelerating, that affixing member. Accelerating an affixing member may generate vibrational energy. In this manner, an affixing member may be suddenly accelerated such that vibrational energy is generated in the affixing member. For example, a roller may be suddenly accelerated to obtain vibrational energy and this vibrating roller may be utilized to affix a truss connector plate to one or more truss members.

At some point (e.g., after a sufficient vibrational energy has been generated) the affixing member may cease to accelerate (e.g., may be moved at a constant speed). Alternatively, at some point, the rate of acceleration may change such that the amount of vibrational energy generated by the affixing member is changed. Moreover, the velocity of an affixing member may be changed in order to realize a variety of useful functions. For example, the velocity of a roller may be changed before that roller contacts a truss connector plate (e.g., contacts a leading edge of a truss connector plate) such that a portion of the impact force is changed.

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is an illustration of two truss connector plates constructed in accordance with the principles of the present invention;

FIG. 2 is an illustration of a connecting system constructed in accordance with the principles of the present invention;

FIG. 3 is an illustration of a truss connecting process constructed in accordance with the principles of the present invention;

FIG. 4 is an illustration of a truss connecting process constructed in accordance with the principles of the present invention;

FIG. 5 is an illustration of a truss connecting system constructed in accordance with the principles of the present invention;

FIG. 6 is a flow chart of a truss connecting process constructed in accordance with the principles of the present invention; and

FIG. 7 is an illustration of manual controls constructed in accordance with the principles of the present invention.

### DETAILED DESCRIPTION OF THE DRAWINGS

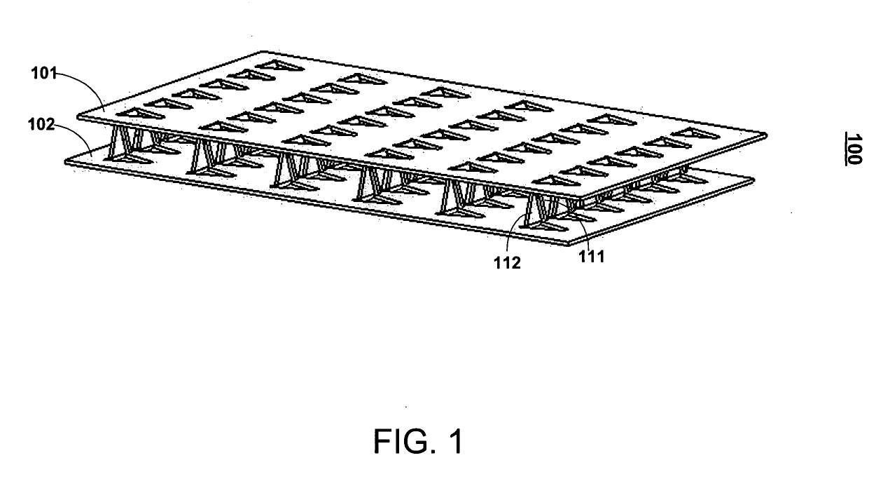

FIG. 1 shows truss connector plate configuration 100 that includes truss connector plates 101 and 102. Truss connector plates 101 and 102 may include any number of connector teeth 111 and 112, respectively.

Truss connector plates 101 and 102 may be used, for example, to connect two truss members (not shown) together. Particularly, truss connector plate 101 may be affixed to one side of the two truss members and truss connector plate 102 may be affixed to the other side of the two truss members. Connecting multiple truss members together in different orientations may be utilized to realize a variety of different types of trusses. Truss members may be fabricated from, for example, a polymer, wood, or any other material used for building trusses or other structures. Truss connector plates 101 and 102 may be fabricated from, for example, steel, iron, copper, or any other metal or material (e.g., any material that is harder than the truss member layers being connected).

Persons skilled in the art will appreciate that the number, and size, of connector teeth 111 and 112 may be representative of the amount of force needed to affix a truss connector plate to a truss member. In this manner, a control system may provide different control signals to a truss connecting system depending on the characteristics of the teeth of a particular truss connector plate.

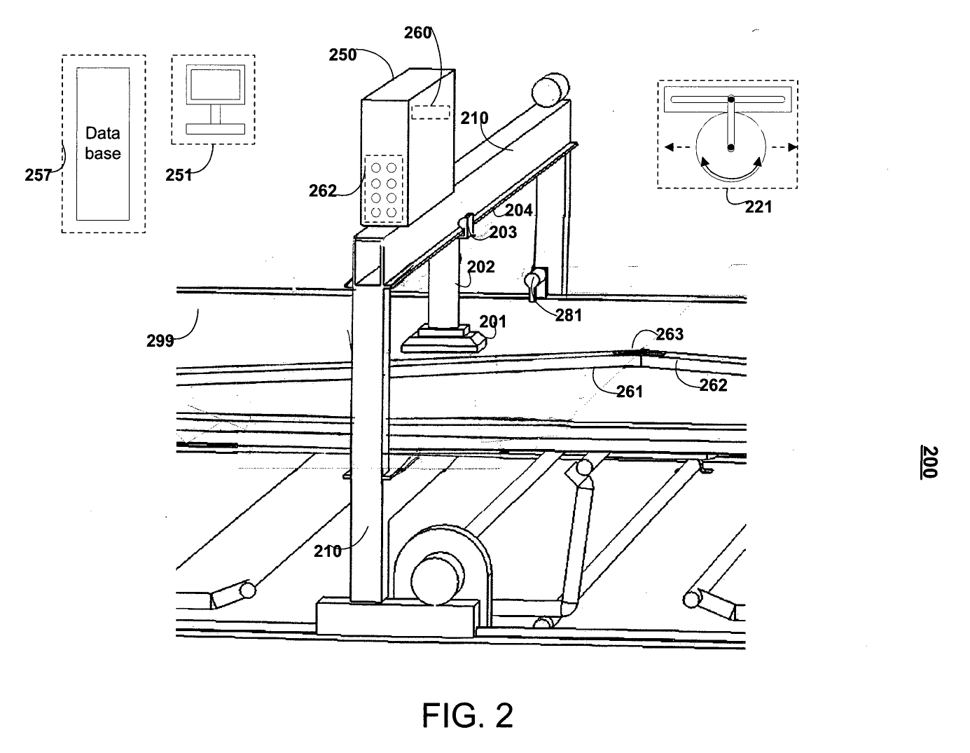

FIG. 2 shows truss member connecting system 200 that includes affixing member 201 located about platform 299. Affixing member 201 may be used, for example, to press a truss connector plate into any number of truss members. Alternatively, affixing member 201 may be similar to affixing member 221. Affixing member 221 may be used, for example, to roll a truss connector plate into any number of truss members. In this manner, affixing members 201 and 221 may be used to affix connector plate 263 to truss members 261 and 262.

Affixing system 200 may operate as follows. Affixing member 201 may be accelerated to a particular speed. Affixing member 201 may then be stopped in such a way that affixing member 201 starts to vibrate. Next, affixing member 201 may be re-accelerated such that a vibrating affixing member 201 comes into contact with, for example, a truss connector plate positioned in the proximity of affixing member 201.

Affixing member 201 may be moved in any direction. For example, affixing member 201 may be mounted on vertical movement member 202. A hydraulic or actuator-based system, for example, may be utilized so that vertical movement member 202 may move affixing member 201 up and down. Affixing member 201 may also be mounted on horizontal movement member 203. A hydraulic system or an actuator-based system, for example, may be utilized to allow horizontal movement member 203 to move laterally. For example, horizontal movement member 203 may be mounted to rail 204 such that member 203 may move along (e.g., parallel to) rail 204.

Persons skilled in the art will appreciate that affixing member 221 may similarly move about a rail. Such a rail may be moved vertically up or down, by a hydraulic or actuator-based system, such that affixing member 221 is provided with the freedom to move vertically.

The movement of the components of system 200 may be controlled by control signals provided by control circuitry. Such control circuitry may be provided, for example, locally on local control system 250, or remotely on remote control system 251. Control signals may be communicated throughout system 200 either directly or by wireless communications (e.g., satellite, cellular, PCS, infrared, wireless Ethernet, wireless USB, or radio communications). The control signals of system 200 are not limited to moving the components of system 200. Instead, the control signals of system 200 may be any signal that is used, for example, to operate the connecting system in a particular manner or to retrieve operating data from the connecting system.

A control signal may represent, for example, a single command to perform a single action (e.g., a particular movement of a component). In more intricate embodiments, however, a control signal may represent multiple settings such as, for example, rate of acceleration, point where affixing member 201 stops, the time that affixing member 201 remains stopped, the vertical acceleration of affixing member 201 after a stop, or the stiffness of the platform supporting affixing member 201. In this manner, a control signal may represent an entire affixing process or a portion of an affixing process.

Control signals may be generated manually or autonomously. Manual control signals may be entered, for example, into interfaces on systems 250 and/or 251. Such interfaces may be, for example, a graphical user interface (GUI) or electrical switches (e.g., switches 262). Alternatively, connecting system 200 may be controlled manually. For example, knob 281 may control the stiffness of structure 210 by tightening or loosening the connection between structure 210 and platform 299. As per another embodiment, other forms of manual controls may be present. For example, a joystick and switches that control the operation of affixing member 201 may be utilized to operate affixing member 201 in accordance with the principles of the present invention.

Remote database 257 may be utilized to store operational profiles. Such operational profiles may include one or more control signals (e.g., a series of control signals or a data structure storing multiple control signals) that may cause connecting system 200 to operate in a particular manner. Alternatively, an operational profile may include a control algorithm that operates, for example, a connecting system. Operational profiles may, for example, be flashed into memory located in the connecting system or a control system.

An operational profile may, for example, correspond to building a particular type of roof truss (e.g., a ten foot long bow-tie roof truss made from Oak truss members). Connecting system 200 may be configured to download any new operational profile from database 257 at a particular time (e.g., midnight) or retrieve particular operation profiles from database 257 when the operational profiles are requested (e.g., a ten foot long Oak bow-tie roof truss). Processor 260 may be utilized, for example, to provide control signals to affixing member 201 based on a particular operational profile.

Additionally, any actuator (or electric motor) of system 200 may, for example, be fabricated with an imbalance such that the actuator (or electric motor) vibrates when being operated. Accordingly, an imbalance in an actuator (or electric motor) moving affixing member 201 may cause affixing member 201 to vibrate when affixing member 201 is moved. Similarly, the actuator (or electric motor) that rolls affixing member 221 may be provided with an imbalance. Alternatively, affixing member 221 may be provided with an imbalance (e.g., different portions of affixing member 221 may be weighted differently).

Persons skilled in the art will appreciate that a sufficient amount of vibrational energy may be generated in an affixing member by a sudden acceleration of that affixing member. As a result, an affixing member does not have to be stopped, or decelerated in order to generate a sufficient amount of vibrational energy to affix a truss connector plate to one or more truss members with reduced-stress.

Generating vibrational energy in an affixing member generally means operating an affixing member in a particular way such that vibrational energy is introduced into that affixing member. In this manner, the phrase generating vibrational energy is not limited to the actual physical generation of vibrational energy in a component. For example, suppose that a motor inside of frame 210 operates the vertical movement of vertical movement member 202. In turn, affixing member 201 is moved vertically. The vertical movement of affixing member 201 may initially cause, for example, frame 210 to vibrate. At least a portion of the vibrational energy of frame 210 may be, for example, introduced into affixing member 201 such that affixing member 201 vibrates. The vibrational energy of affixing member 201, however, was introduced because of a particular operation of affixing member 201. In this manner, the terms introduced and generated are synonymous throughout this application when referencing the creation of vibrational energy in a component (e.g., an affixing member). Similarly, any operation discussed in connection with affixing member 201 may be provided in connection with affixing member 221.

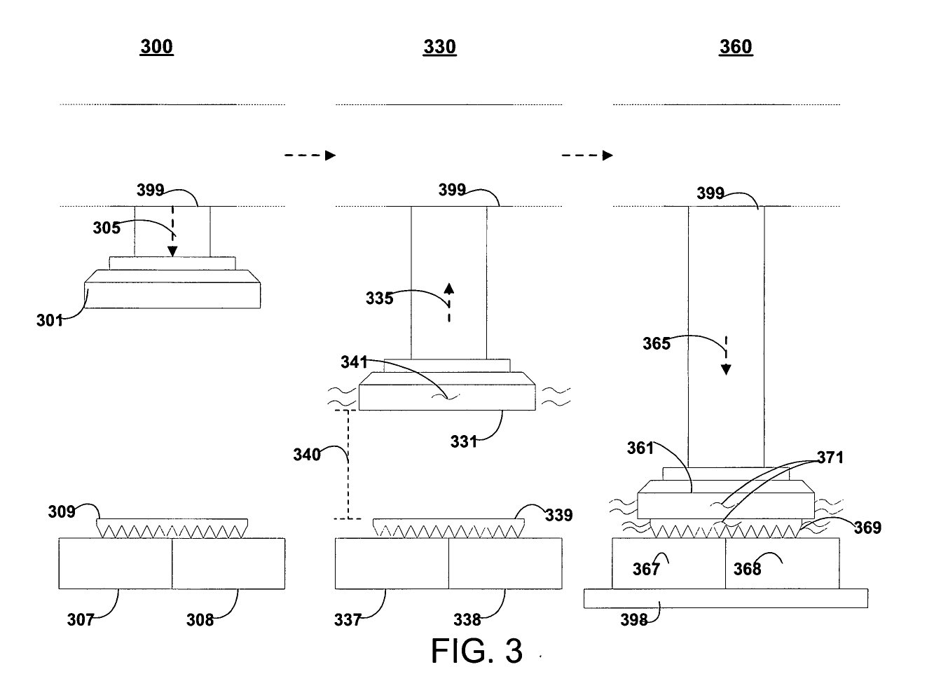

FIG. 3 shows affixing process steps 300, 330, and 360 which may be utilized to affix a truss connector plate to one or more truss members.

In process step 300, affixing member 301 may be aligned with truss connector plate 309. Additionally, truss connector plate 309 may be aligned with truss members 307 and 308. Affixing member 301 may then be accelerated towards (or brought to a particular speed in the direction of) truss connector plate 309 (e.g., direction 305).

Turning next to process step 330, affixing member 331 may be decelerated or stopped (e.g., with a force in direction 335) such that vibrational energy 341 is generated in affixing member 331. The distance at which the deceleration occurs, the duration of the deceleration, and the magnitude of the acceleration of affixing member 331 may affect the vibrational profile of affixing member 331 when affixing member 331 contacts truss connector plate 339.

In order for truss connector plate 339 to remain aligned with truss members 337 and 338, truss connector plate 339 may be initially, but minimally, affixed to truss members 337 and 338. Such a minimal affixing may be done manually (by the manual hammering of truss connector plate 339 into truss members 337 and 338). Alternatively, affixing member 331 may be utilized (e.g., without vibrational energy) to press truss connector plate 339 slightly (e.g., roughly 1-5 millimeters) into truss members 337 and 338. As a result of a small, initial affixing of truss connector plate 339 to truss members 337 and 338, the alignment of truss connector plate 339 with affixing member 331 may not change if, for example, an amount of vibrational energy 341 is introduced into the platform supporting truss members 337 and 338. Truss members 337 and 338 may also be secured to, for example, the working platform (not shown) in order to maintain a particular alignment with affixing member 331.

Persons skilled in the art will appreciate that vibrational energy 341 may be generated in a variety of different ways. For example, affixing member 331 may be rapidly accelerated. This rapid change in motion, albeit an increase in overall speed, may generate vibrational energy 341 in affixing member 331.

In process step 360, affixing member 361 having vibrational energy/profile 371 may be moved in direction 365. Thus, affixing member 361 may come into contact with connector plate 369 such that connector plate 369 attains a vibrational energy/profile representative of vibrational energy/profile 371. Affixing member 361 may force truss connector plate 369 into truss members 367 and 368 until, for example, affixing member 361 is a particular distance from working platform 398 (e.g., the distance equal to the height of one of the truss members plus the height of truss connector plate 369 minus the height of the teeth of truss connector plate 369). The distance of affixing member 361 from the working platform may be determined, for example, by the amount that affixing member 361 has been extended from structure 399.

Persons skilled in the art will appreciate that process steps 300 and 330 are not needed to introduce vibrational energy into affixing member 361. Affixing member 361 may only be accelerated/decelerated before contacting truss connector plate 369 such that vibrational energy is generated in affixing member 361. For example, affixing member 361 may be suddenly accelerated from the start of movement to generate sufficient vibrational energy.

Persons skilled in the art will also appreciate that a connecting system may be generally modeled after a mass-spring system. Particularly, the components that move (e.g., vertical movement member 202 of FIG. 2 and affixing member 201 of FIG. 2) may be modeled as having a mass (m). Vertical movement member may act like a spring and have a particular stiffness (k). Accelerating vertical movement member 202 of FIG. 2 at rate (a) may create a force (F) that is equal to (m)*(a). Such a force may stretch the spring (e.g., vertical movement member 202 of FIG. 2) by a particular amplitude (A). When the spring (e.g., vertical movement member 202) stops accelerating (e.g., reaches and maintains a constant speed), force (F) is removed and the spring (e.g., vertical movement member 202 of FIG. 2) may begin to oscillate. As can be seen, the process of accelerating and decelerating a component (e.g., a vertical member) may be equivalent to stretching out a spring with a mass connected to the spring's moveable end and then releasing the stretched-out spring. The mass may continue to oscillate with no external force acting on the mass.

Particular parameters may be adjusted in a connecting system in order to optimize the vibrations generated in an affixing member (e.g., generate a different vibrational profile). For example, the vibrational profile may be adjusted by adjusting the acceleration of a movement member (e.g., a vertical or horizontal movement member) and the affixing member. Alternatively, the vibrational profile may be adjusted by adjusting the stiffness of a movement member. Alternatively still, the vibrational profile may be adjusted by adjusting the mass of a movement member and/or the affixing member. Furthermore, the vibrational profile may be adjusted by actively, or passively, adjusting an imbalance in motors utilized to move the components of a connecting system. Also, adjusting the vertical height, or the linear speed, of rollers may also change the vibrational profile (as well as changing the impact force when the leading edge of a truss connector plate is contacted). As can be seen, there are a variety of ways to manipulate a vibrational profile without the need for dedicated vibration units.

A processor may be utilized to determine the vibrational profile needed to affix a particular truss connector plate to a particular truss member for a particular structure. Such a processor may also adjust (via control signals) characteristics of a truss connecting system such that a particular vibrational profile is obtained. In this manner a processor may determine what changes to the characteristics of a truss connecting system are needed to realize a particular vibrational profile. Such steps may also be performed manually.

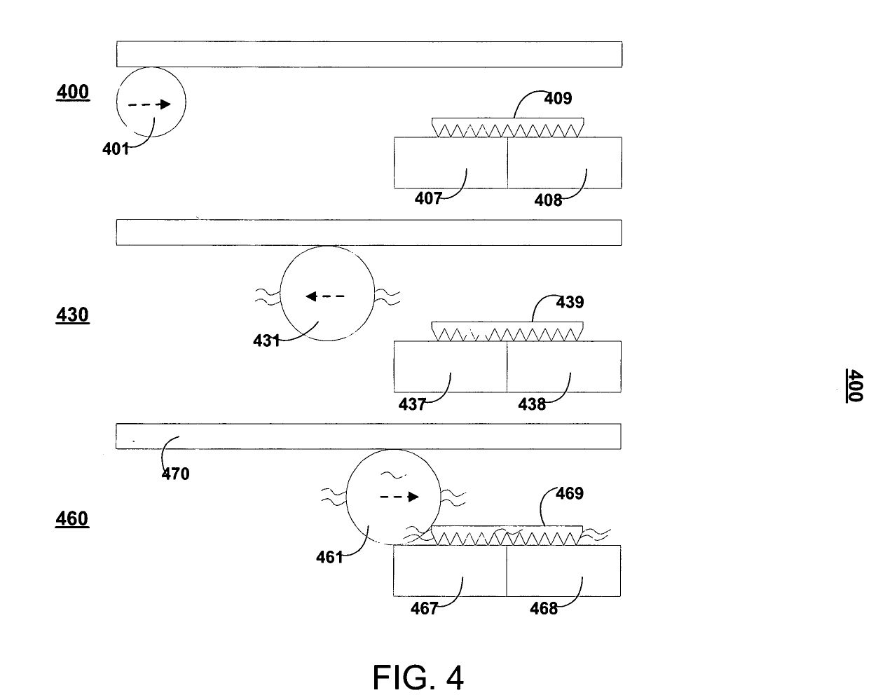

FIG. 4 shows process steps 400, 430, and 460 that may be utilized to affix a truss connector plate to one or more truss members. In process step 400, affixing member 401 may be accelerated (or moved towards) truss connector plate 409, and truss members 407 and 408. Affixing member 401 may be moved a particular distance until the movement profile of affixing member 401 is changed in process step 430. For example, affixing member 431 may be decelerated (or stopped for a particular amount of time) such that vibrational energy is generated in affixing member 431. Next, a vibrating affixing member 431 may be moved toward truss connector plate 439 and truss members 437 and 438. In process step 460, a vibrating affixing member 461 comes into contact with truss connector plate 469 such that truss connector plate 469 obtains vibrational energy. As affixing member 461 moves across truss connector plate 469, truss connector plate 469 is affixed to truss members 467 and 468. As illustrated, affixing member 461 rolls over connector plate 469.

One advantage of a rolling affixing member is that a rolling affixing member does not have to be stopped at a particular time—the rolling member simply rolls over the truss connector plate. In this manner, more than one truss connector plate may be affixed to truss members in a single roll. However, a rolling affixing member may have to be initially set-up to a particular height with respect to the working platform (e.g., a height substantially equal to the height of a truss member plus the height of the connector plate minus the height of the teeth of the connector plate).

Persons skilled in the art will appreciate that process steps 400 and 430 are not needed to introduce vibrational energy into affixing member 461. Affixing member 461 may only be accelerated/decelerated before contacting truss connector plate 469 such that vibrational energy is generated in affixing member 461. For example, affixing member 461 may be suddenly accelerated from the start of movement to generate sufficient vibrational energy. Persons skilled in the art will appreciate that affixing member 461, if embodied as a roller, may continue to move in the same direction after, for example, truss connector plate 469 is affixed to truss members 467 and 468.

Affixing member 461, if embodied as a roller, may “roll” over truss connector plate 469 multiple times and in multiple directions. Affixing member 461 may “roll” over truss connector plate 469 at a first height from, for example, truss member 467. Affixing member 461 may then “roll” over truss connector plate 469 a second time, in the opposite direction, at a second height from truss member 467 (e.g., a smaller height). For each “roll” across connector plate 469, affixing member 461 may be operated to generate a vibrational energy in affixing member 461. Similarly, affixing member 201 of FIG. 200 may be “pressed” into a truss connector plate multiple times and at multiple heights.

Additionally, a force acting on affixing member 461 may be adjusted before affixing member 461 contacts the leading edge of truss connector plate 469. Changing the speed of a roller before contact with a truss connector plate may, for example, change the characteristics of the impact force on that connector plate. In this manner, a truss connector plate may be more efficiently affixed to one or more truss members.

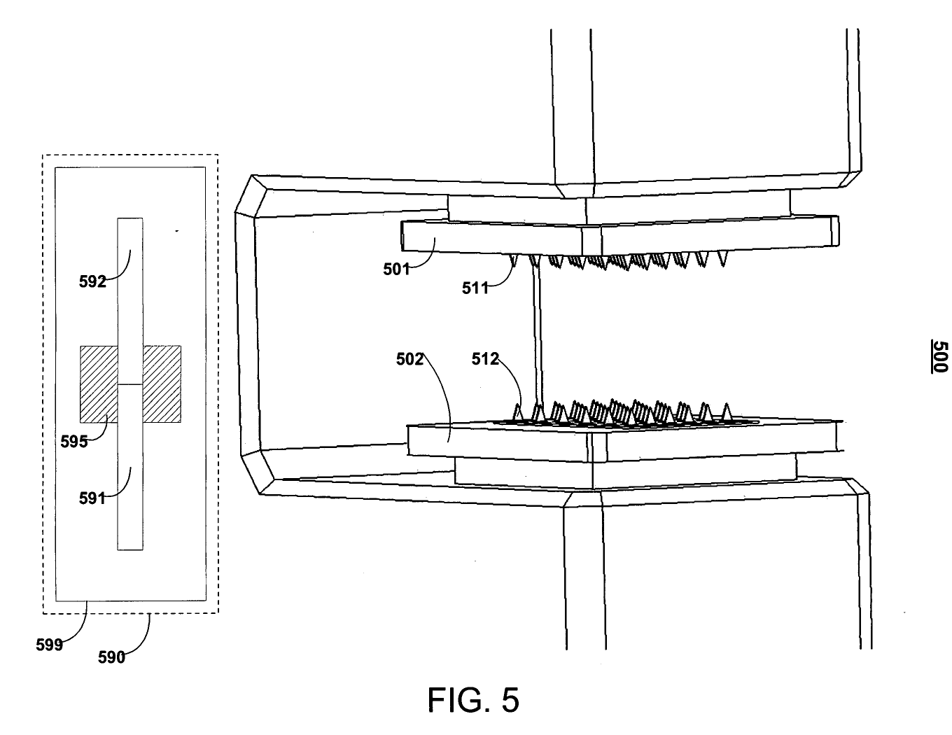

FIG. 5 shows connecting system 500 that includes two affixing members 501 and 502. Affixing members 501 and 502 may be of a pressing configuration as illustrated or may, alternatively, be of a rolling configuration.

Connector plates 511 and 512 may be positioned and locked onto affixing members 501 and 502, respectively. Locking truss connector plates to an affixing member may be done mechanically (e.g., by fasteners) or electrically (e.g., electrostatically or electromagnetically). In this manner, affixing members 501 and 502 may simultaneously affix connector plates to both sides of one or more truss members. Alternatively, affixing members 501 and 502 may take turns affixing connector plates to a side of one or more truss members.

Configuration 590 may be utilized to assist connecting system 500. Particularly, aperture 595 may be included in platform 599. Truss members 592 and 591 may be aligned and locked onto platform 599 such that the connection between truss members 592 and 591 is aligned with aperture 595. In this manner, affixing member 501 may be aligned above aperture 595 while affixing member 502 may be aligned underneath aperture 595. Truss members 592 and 591 may, for example, be locked mechanically (e.g., fasteners).

Each of affixing members 501 and 502 may be operated to generate a vibrational profile. In this manner, affixing members 501 may be decelerated or stopped before (or when) truss connector plates 511 and 512 come into contact with truss members such that truss connector plates 511 and 512 vibrate while being affixed.

Persons skilled in the art will appreciate that truss connector plates 511 and 512 may already be initially affixed to truss members. By initially affixing connector plates to truss members, the connector plates may retain a particular alignment until fully affixed into the truss members.

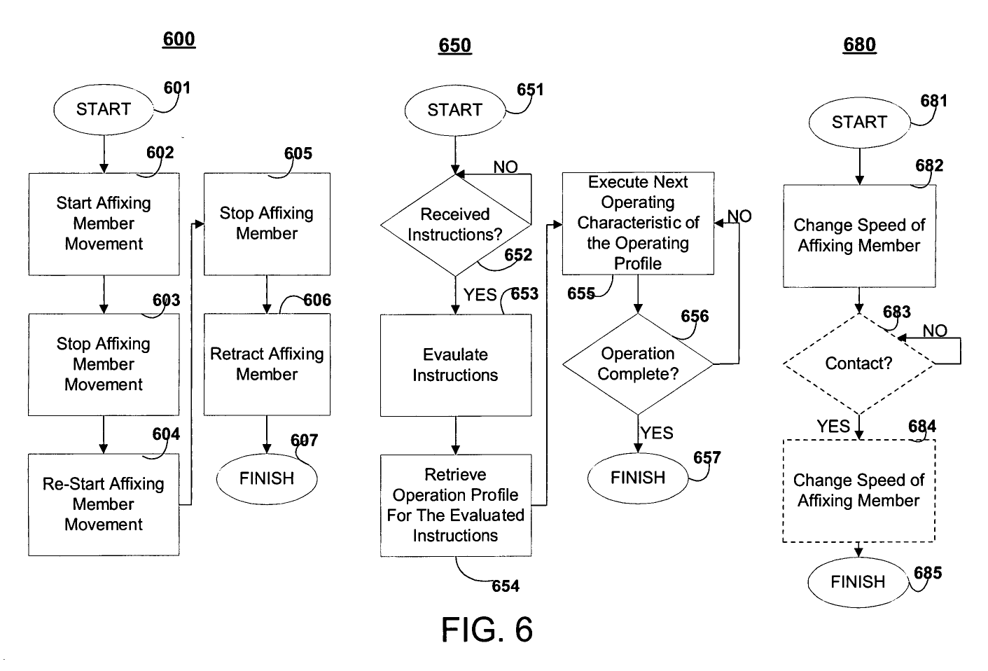

FIG. 6 shows flow charts 600, 650, and 680 that may be utilized to affix truss connector plates to truss members.

Flow chart 600 occurs as follows. The process starts at step 601 and forces an affixing member to move in step 602. Next, the movement of the affixing member is changed (e.g., stopped) in step 603 such that vibrational energy is introduced in the affixing member. Then, step 605 occurs and a vibrating affixing member continue to move toward a truss connector plate. Persons skilled in the art will appreciate that if deceleration occurs in step 603, and the affixing member is moving when vibrational energy is introduced, then step 604 is not needed—the affixing member may just continue to move at, for example, the speed affixing member was moving when vibrational energy was introduced. After a truss connector plate is affixed to one or more truss members, the affixing member may be stopped in step 605. Next, the affixing member may be retracted in step 606 such that a new affixing process may begin. Otherwise, the process may stop at step 607.

Flow chart 650 may start at step 651. At step 652, the truss connecting system may wait for instructions. If instructions are received step 653 may be executed or step 652 may be repeated. In step 653, the instructions are evaluated and the operation profile for the truss connecting system is retrieved, if needed, in step 654. Person skilled in the art will appreciate that if the instructions are, for example, “move affixing member 10 inches” then an operation profile is not needed. However, if the instructions are “affix joint X of a bowtie roof truss made from maple truss members,” then the retrieval of an operational profile may be needed.

In steps 655 and 656, the particular operating steps of an operating profile are executed in order. Persons skilled in the art will appreciate that such operating steps may be contingent on other steps. For example, suppose an operating step is “move affixing member 10 inches.” The next operating step may be, for example, “confirm a 10 inch movement.” In this manner, the next operating step may be contingent on the answer to the operating step “confirm a 10 inch movement.” The process of affixing a truss connector plate to a truss member may be completed, for example, after an operational profile has been exhausted at step 657.

Flow chart 680 may be utilized to operate an affixing member. Flow chart 680 begins at step 681. In step 682, the speed of the affixing member is changed such that vibrational energy is generated in the affixing member. The process may then continue into step 683 or may simply finish at step 685. For example, if the affixing member is a roller then an additional roller movement may not be required, after a vibrational energy is generated, to properly affix a truss connector plate to one or more truss members.

If step 683 is included then the speed of the affixing member may be changed in step 684 when the affixing member contacts a truss connector plate or affixes a truss connector plate to a truss member. For example, if the affixing member is a presser, then the speed of the affixing member may be changed to zero after the truss connector plate has been affixed to a truss member. As per another example, if the affixing member is a roller, then the speed of the affixing member may be changed before, during, or after the affixing member contacts the leading edge of truss connector plate. Changing the speed of the roller before contact with a truss connector plate may, for example, change the characteristics of the impact force on that connector plate that may cause additional vibration of the affixing member. In this manner, a truss connector plate may be more efficiently affixed to one or more truss members. Changing the speed of a roller after the roller contacts a truss connector plate (e.g., after affixing) may, for example, allow the roller to obtain a vibrational energy so the roller may affix a second truss connector plate.

Persons skilled in the art will appreciate that the resonant frequencies (and associated harmonics) of a vibrating affixing member and connecting system may depend on the mass of the affixing member and the stiffness of the affixing member (or the structure supporting the affixing member). Similarly, the resonant frequencies of an affixing member may depend on other components of a connecting system such as, for example, the mass and stiffness of a movement member (e.g., a horizontal of a vertical movement member) that the affixing member is coupled to. In this manner, the resonant frequency may be the square root of the stiffness of the affixing member divided by the square root of the mass of the affixing member (harmonics may be integer multiples of the resonant frequency).

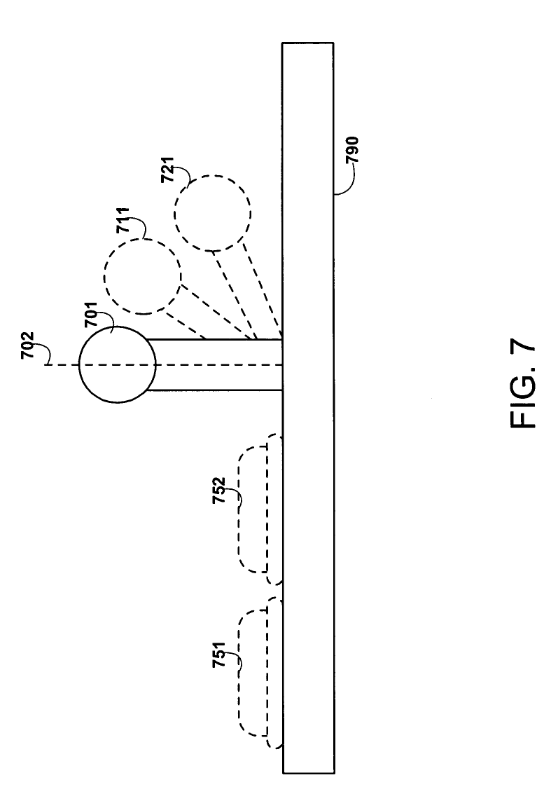

Turning now to FIG. 7, manual controls 700 are shown that include joystick 701 and buttons 751 and 752. Such controls may be utilized to move any component of a truss connecting system (e.g., the components of truss connecting system 200 of FIG. 2) or initiate any process (e.g., download/execute/select an operational profile).

Joystick 701 may be utilized to move a movement member, or an affixing member, in a particular direction. Persons skilled in the art will appreciate that changing the velocity of a movement member, or an affixing member, may introduce vibrational energy into an affixing member. Accordingly, manual controls 700 may be configured to allow a user to not only control the direction of a component, but also the velocity of that component. Particularly, joystick 701 may be configured such that as joystick 701 is moved further away from resting location 702, the velocity of that component changes. For example, a velocity may be associated with each joystick position such that a component is moved at one velocity when joystick 701 is at position 711, but the component is moved at a different velocity when joystick 701 is at position 721.

Alternatively, joystick 701 may be configured to operate similar to, for example, a throttle. Particularly, the movement of joystick 701 to the left of resting location 702 may accelerate the movement of a component, while movement of joystick 701 to the right of resting location 702 may decelerate the movement of that component. Persons skilled in the art will appreciate that multiple joysticks, in multiple configurations, may be utilized. For example, one joystick may be configured to control the direction of movement for a component while a different joystick may control the velocity, or acceleration, of that component.

Alternatively, buttons 751 and 752 may be utilized to change the acceleration, or the velocity, of a component being moved by a joystick. For example, button 751 may be utilized to increase the velocity of a component while button 752 may be utilized to decrease the velocity of a component.

From the foregoing description, persons skilled in the art will recognize that this invention provides vibrational energy in a truss connecting system. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications therefrom which are within the spirit of the following claims.

What is claimed is:

1. A method for operating a truss connecting system comprising:
operating a movement member to introduce vibrational energy into an affixing member, said movement member being coupled to said affixing member;
causing said affixing member to make physical contact with a truss connector plate to transfer at least a portion of said vibrational energy to said truss connector plate; and
affixing said truss connector plate, with said at least a portion of said vibrational energy, to at least one truss member.

2. The method of claim 1, wherein said operating comprises accelerating said affixing member.

3. The method of claim 1, wherein said operating comprises decelerating said affixing member.

4. The method of claim 1, further comprising moving said affixing member towards said truss connector plate after said vibrational energy is introduced into said affixing member.

5. The method of claim 1, wherein said operating comprises:
accelerating said affixing member;
stopping said affixing member after said accelerating; and
re-accelerating said affixing member after said stopping.

6. The method of claim 1, wherein said affixing member comprises a roller.

7. The method of claim 6, wherein said movement member comprises a horizontal movement member.

8. The method of claim 7, wherein said horizontal movement member moves along a rail.

9. The method of claim 6, wherein said operating comprises horizontally accelerating said roller towards said truss connector plate.

10. The method of claim 5, further comprising horizontally moving said affixing member towards said truss connector plate after said operating in which said vibrational energy is introduced, wherein said operating comprises changing the velocity of said affixing member.

11. The method of claim 10, further comprising horizontally moving said affixing member towards said truss connector plate before said operating.

12. The method of claim 11, further comprising horizontally moving said affixing member towards a second truss connector plate after said affixing.

13. The method of claim 1, wherein said affixing member comprises a presser.

14. The method of claim 13, wherein said movement member comprises a vertical movement member.

15. The method of claim 13, wherein said operating comprises vertically accelerating said affixing member towards said truss connector plate.

16. The method of claim 13, further comprising vertically moving said affixing member towards said truss connector plate after said operating, wherein said operating comprises changing the velocity of said affixing member.

17. The method of claim 16, further comprising vertically moving said affixing member towards said truss connector plate before said operating.

18. The method of claim 16, further comprising stopping said movement after said operating at a predetermined distance from said at least one truss connector plates.

19. The method of claim 1, further comprising determining the amount of said vibrational energy that is to be introduced into said affixing member.

20. The method of claim 19, wherein said determining occurs in a processor.

21. The method of claim 1, wherein said operating occurs in accordance with an operational profile stored in memory.

22. The method of claim 21, wherein said memory is located in a remote database.

23. The method of claim 21, wherein said operational profile is representative of user input to a graphical user interface.

24. The method of claim 1, further comprising adjusting the stiffness of a component of said connecting system to adjust the amount of said vibrational energy.

25. The method of claim 1, further comprising adjusting the mass of a component of said connecting system to adjust the amount of said vibrational energy.

26. The method of claim 1, further comprising initially affixing said truss connector plate to said at least one truss member.

27. The method of claim 1, wherein said initially affixing comprises initially contacting said affixing member to said truss connector plate.

28. The method of claim 1, further comprising aligning said affixing member with said truss connector plate.

29. The method of claim 28, wherein said affixing member comprises a roller and said aligning comprises horizontally aligning said roller to said truss connector plate.

30. The method of claim 29, wherein said affixing member comprises a presser and said aligning comprises vertically aligning said presser to said truss connector plate.

31. The method of claim 1, further comprising:
providing a second affixing member;
operating said second affixing member such that said second affixing member affixes a second truss connector plate into said at least one truss members.

32. The method of claim 31, wherein said operating said second affixing member comprises operating a second movement member coupled to said second affixing member.

33. The method of claim 31, wherein said operating said second affixing member comprises introducing a second vibrational energy into said second affixing member.

34. A method of operating an affixing member of a truss connecting system, said method comprising:
determining an amount of vibrational energy needed to affix a truss connector plate into one or more truss members with reduced-stress;
moving said affixing member towards a truss connector plate;
adjusting the velocity of said movement such that said vibrational energy is introduced into said affixing member;
contacting said affixing member with said vibrational energy to said truss connector plate such that at least a part of said vibrational energy is introduced to said truss connector plate; and
affixing said truss connector plate to said at least one truss member.

35. The method of claim 34, wherein said adjustment of said velocity decreases the velocity of said movement.

36. The method of claim 34, wherein said adjustment of said velocity increases the velocity of said movement.

37. The method of claim 34, wherein said adjustment of said velocity occurs as a result of an adjustment in the movement of a vertical movement member coupled to said affixing member.

38. The method of claim 34, wherein said adjustment of said velocity occurs as a result of an adjustment in the movement of a horizontal movement member coupled to said affixing member.

39. The method of claim 34, wherein said determining is performed in a processor.

40. The method of claim 34, wherein said velocity is changed during said contacting of said affixing member to said truss connector plate to change the impact force on said truss connector plate.

41. The method of claim 34, wherein said affixing member is a presser.

42. The method of claim 41, wherein said adjusting increases the velocity of a vertical movement member coupled to said presser.

43. The method of claim 42, further comprising re-adjusting said movement of said vertical movement member after said vibrational energy has been introduced, wherein said re-adjusting maintains the velocity of said affixing member at a constant velocity before said contacting.

44. The method of claim 41, wherein said adjusting decreases the velocity of a vertical movement member coupled to said presser.

45. The method of claim 44, further comprising re-adjusting said movement of said vertical movement member after said vibrational energy has been introduced, wherein said re-adjusting maintains the velocity of said affixing member at a constant velocity before said contacting.

46. The method of claim 44, further comprising re-adjusting said movement of said vertical movement member after said vibrational energy has been introduced, wherein said re-adjusting increases the velocity of said affixing member before said contacting.

47. The method of claim 34, wherein said affixing member is a roller.

48. The method of claim 47, wherein said adjusting increases the velocity of a horizontal movement member coupled to said roller.

49. The method of claim 48, further comprising re-adjusting said movement of said horizontal movement member after said vibrational energy has been introduced, wherein said re-adjusting maintains the velocity of said affixing member at a constant velocity before said contacting.

50. The method of claim 47, wherein said adjusting decreases the velocity of a horizontal movement member coupled to said roller.

51. The method of claim 50, further comprising re-adjusting said movement of said horizontal movement member after said vibrational energy has been introduced, wherein said re-adjusting maintains the velocity of said affixing member at a constant velocity before said contacting.

52. The method of claim 50, further comprising re-adjusting said movement of said horizontal movement member after said vibrational energy has been introduced, wherein said re-adjusting increases the velocity of said affixing member before said contacting.

53. The method of claim 34, further comprising
aligning said affixing member with said truss connector plate.

54. A method of operating an affixing member of a truss connecting system, said method comprising:
coupling a truss connector plate to said affixing member;
aligning said affixing member with at least one truss member;
moving said affixing member towards said at least one truss member;
introducing a vibrational energy into said truss connector plate by stopping said movement of said affixing member;
accelerating said affixing member towards said at least one truss member after said vibrational energy has been introduced into said truss connecting plate; and
affixing said truss connector plate with said vibrational energy to at least one truss member.

55. The method of claim 54, further comprising uncoupling said truss connector plate from said affixing member.

56. A method for connecting a truss connector plate to at least one truss member comprising:
retrieving a vibrational profile from a memory;
operating said movement member such that said vibrational profile is introduced into said affixing member; and
introducing at least a portion of said vibrational profile into said truss connector plate;
affixing said truss connector plate, having said at least a portion of said vibrational profile, to said at least one truss member.

57. A method for connecting a truss connector plate to at least one truss member comprising:
retrieving an operational profile from a memory;
operating said movement member in accordance with said operational profile, wherein said operating introduces a vibrational energy into said affixing member; and
introducing at least a portion of said vibrational energy into said truss connector plate;
affixing said truss connector plate, having said at least a portion of said vibrational energy, to said at least one truss member.

58. The method of claim 57, wherein said memory is located in a remote database.

59. A method for connecting a truss connector plate to at least one truss member comprising:
determining a vibrational profile for an affixing member;
choosing the mass of a movement member based on said determination;
choosing a stiffness of said affixing member based on said determination;
coupling said movement member to said affixing member;
operating said movement member in such a way that said vibrational profile is introduced into said affixing member; and
contacting said affixing member to said truss connector plate.

60. A system for connecting a truss connector plate to at least one truss member, comprising:
a memory;
a plurality of operational profiles stored in said memory;
a movement member;
an affixing member, wherein said movement member is coupled to said affixing member;
an interface operable to accept input, wherein said input is utilized to select one of said plurality of operational profiles; and
a processor, wherein said processor provides control signals to said movement member based on said selected one of said plurality of operational profiles and said control signals cause said affixing member to affix said truss connector plate to said at least one truss members.

61. A system for connecting a truss connector plate to at least one truss member, comprising:
a memory;
a plurality of operational profiles stored in said memory;
a movement member;
an affixing member, wherein said movement member is coupled to said affixing member;
an interface operable to accept input, wherein said input is utilized to select one of said plurality of operational profiles; and
a processor, wherein said processor provides control signals to said movement member based on said selected one of said plurality of operational profiles, said control signals cause a vibrational energy to be introduced into said affixing member, and said control signals cause said affixing member, having said vibrational energy, to affix said truss connector plate to said at least one truss member.

62. A system for connecting a truss connector plate to at least one truss member, comprising:
a memory;
a movement member;
an affixing member, wherein said movement member is coupled to said affixing member;
a plurality of operational profiles stored in said memory, wherein one of said plurality of operational profiles is selected based on the amount of vibrational energy said operational profiles introduce into said affixing member; and
a processor, wherein said processor provides control signals to said movement member based on said selected one of said plurality of operational profiles and said control signals cause said vibrational energy to be substantially introduced into said affixing member, and said control signals cause said affixing member, having said vibrational energy, to affix said truss connector plate to said at least one truss member.

63. A truss connecting system comprising:
at least one truss member;
a connector plate;
an affixing member for affixing said connector plate to said at least one truss member;
a movement member coupled to said affixing member;
a joystick having a resting location, wherein said joystick controls both the velocity and direction of movement of said movement member.
